(19) United States
(12) Patent Application Publication
(10) Pub. No.: US 2026/0342673 A1
(43) Pub. Date: Oct. 29, 2026

(54) INFERENCE-CONTEXT HISTORY IN A COMMUNICATION NETWORK

(71) Applicant: Nokia Solutions and Networks Oy, Espoo (FI)

(72) Inventors: Dario BEGA, Stuttgart (DE); Stephen MWANJE, Munich (DE)

(21) Appl. No.: 18/998,875

(22) PCT Filed: Aug. 10, 2022
(86) PCT No.: PCT/EP2022/072394

§ 371 Date: Jan. 27, 2025

(51) Int. Cl. H04L 41/16; G06N 5/04; H04B 17/391; H04L 41/147; H04W 24/08

(52) U.S. Cl. CPC H04L 41/16; G06N 5/04; H04B 17/3913; H04L 41/147; H04W 24/08

(57) ABSTRACT

Some embodiments relate to network data analytics in a communication network. In some embodiments, an inference output generated by an AI model is accessed. The inference output is generated in a network context of a communication network. Data indicative of the network context is collected. The inference output is stored together with the data indicative of the network context as inference-context history. The inference-context history is used for network data analytics of the communication network.

### TECHNICAL FIELD

The present disclosure generally relates to the field of communications. In particular, some embodiments relate to network data analytics in a communication network.

### BACKGROUND

Artificial intelligence and machine learning techniques are being increasingly employed in mobile communication technologies and particularly in fifth generation (5G) and subsequent network technologies. For example, Network data analytics function (NWDAF) in 5G core (5GC) generates analytics by processing management and network data. NWDAF may use artificial intelligence (AI) and/or machine learning (ML) techniques.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

According to some aspects, there is provided the subject matter of the independent claims. Some further aspects are defined in the dependent claims.

According to a first aspect, an apparatus comprises: at least one processor; and at least one memory including computer program code, the at least one memory and the computer program code being configured, with the at least one processor, to cause the apparatus to perform operations comprising: for one or more AI models: accessing an inference output generated by the AI model, the inference output being generated in a network context of a communication network; collecting data indicative of the network context; and storing, as inference-context history, the inference output together with the data indicative of the network context; and using the inference-context history for network data analytics of the communication network.

According to an example embodiment of the first aspect, using the inference-context history for network data analytics comprises: selecting, among the one or more AI models, an AI model for performing the network data analytics, the AI model being selected based on the inference-context history; and running the selected AI model to produce the network data analytics.

According to an example embodiment of the first aspect, storing the inference output together with the data indicative of the network context comprises: associating the network context with a label; and storing the inference output together with the label.

According to an example embodiment of the first aspect, storing the inference output together with the data indicative of the network context comprises associating data indicative of the network context with a label; and wherein selecting the AI model for performing the network data analytics comprises selecting the AI model based on the inference-context history associated with the label.

According to an example embodiment of the first aspect, associating the network context with the label comprises: performing a similarity check between the data representative of the network context and data representative of a historical network context stored in a context-label table; assigning a label to the network context based on the result of the similarity check; and updating the context-label table by storing the data indicative of the network context together with the label in the context-label table.

According to an example embodiment of the first aspect, the inference-context history for network data analytics comprises: monitoring a performance of one or more of the AI models to be used for network data analytics, the performance of the AI model being monitored by analyzing the inference-context history associated with the AI model.

According to an example embodiment of the first aspect, the inference output is a prediction for a parameter, and wherein using the inference-context history for network data analytics comprises: comparing the prediction for the parameter with a measured value of the parameter; and triggering a retraining of the AI model based on determining that the prediction for the parameter does not match the measured value of the parameter.

According to an example embodiment of the first aspect, the data indicative of the network context comprises one or more of: a slice load level, a network function load, a network performance or user equipment related analytics, a general network state, or information about Area of Interest sub-areas type.

According to a second aspect, a method, comprises: for one or more AI models: accessing an inference output generated by the AI model, the inference output being generated in a network context of a communication network; collecting data indicative of the network context; and storing, as inference-context history, the inference output together with the data indicative of the network context; and using the inference-context history for network data analytics of the communication network.

According to a third aspect, an apparatus comprises: means for accessing an inference output generated by the AI model, the inference output being generated in a network context of a communication network; means for collecting data indicative of the network context; means for storing, as inference-context history, the inference output together with the data indicative of the network context; and means for using the inference-context history for network data analytics of the communication network.

According to a fourth aspect, a computer program comprises instructions for causing an apparatus to perform at least the following: for one or more AI models: accessing an inference output generated by the AI model, the inference output being generated in a network context of a communication network; collecting data indicative of the network context; storing, as inference-context history, the inference output together with the data indicative of the network context; and using the inference-context history for network data analytics of the communication network.

### BRIEF DESCRIPTION OF THE DRAWINGS

The accompanying drawings, which are included to provide a further understanding of the example embodiments and constitute a part of this specification, illustrate example embodiments and together with the description help to explain the principles of the example embodiments. In the drawings:

FIG. 1 illustrates an example of a communication network.

FIG. 2 is a signaling chart illustrating an example method for configuring the tracking of inference-context history.

FIG. 3 is a signaling chart illustrating an example method for building and storing network context information.

FIG. 4 is a signaling chart illustrating an example method for inference-context history tracking and storing.

FIGS. 5A, 5B and 5C are signaling charts illustrating example methods for AI/M model selection using inference-context history.

FIG. 6 illustrates an example embodiment of the subject matter described herein illustrating a flow chart representation of a method.

Like reference numerals are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms in which the present disclosure may be constructed or utilized. The description sets forth the functions of the example and the sequence of steps for constructing and operating the example. However, the same or equivalent functions and sequences may be accomplished by different example embodiments.

Applications and/or functions using AI models, and in particular ML models, may be applied in different network contexts that may result in different outputs at inference time. To manage an inference performance of the AI models it may be necessary to track and store the inference outputs of the AI models and to correlate these inference outputs with the network context in which they were generated.

Some embodiments provide a mechanism to relate an inference history of one or more AI models with the network context in which these inferences were made. Some embodiments provide a mechanism that tracks a history of decisions taken by the different analytics or their AI models. Some embodiments provide a mechanism that collaborate these decisions with the network context in which these decisions have been taken. Some embodiments allow an analytics consumer to characterize the quality of the produced analytics based on the historical decisions taken by the AI models.

Some embodiments use the inference history for analytics producer selection (e.g., based on the actual mobile network context or use case), for AI model performance monitoring and management (e.g., retraining of an AI model not working properly on a specific use case/network context), and/or for understanding AI model behavior.

Some embodiments allow the network operator and/or management to collect inference history and relate it to the network context. Some embodiments enhance NWDAF functionalities to enable it to automatically build context information on which an AI model is run and store it along with the inference outputs (e.g., decision, prediction, recommendation, analytics, statistics) produced by the AI model.

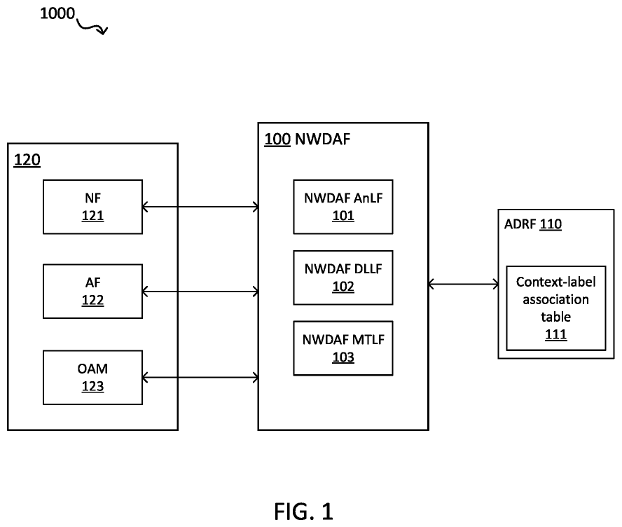

FIG. 1 illustrates an example system, where various embodiments of the present disclosure may be implemented. The system may comprise a communication network 1000, for example a fifth generation (5G) new radio (NR) network. At least in some embodiments, the communication network 1000 may comprise one or more massive machine-to-machine (M2M) network(s), massive machine type communications (mMTC) network(s), internet of things (IoT) network(s), industrial internet-of-things (IIOT) network(s), enhanced mobile broadband (eMBB) network(s), ultra-reliable low-latency communication (URLLC) network(s), and/or the like. In other words, the communication network 1000 may be configured to serve diverse service types and/or use cases and may logically be seen as comprising one or more networks.

Communication network 1000 may be configured for example in accordance with the 5G digital cellular communication network, as defined by the 3rd Generation Partnership Project (3GPP). In one example, communication network 1000 may operate according to 3GPP 5G NR (New Radio). It is however appreciated that example embodiments presented herein are not limited to this example network and may be applied in any present or future wireless communication networks, or combinations thereof, for example other type of cellular networks, short-range wireless networks, broadcast or multicast networks, or the like.

Communication network 1000 may comprise a Network data analytics function (NWDAF) 100. NWDAF 100 may collect network data, perform network analytics and provide network analytics to NWDAF service consumers 120. A single instance or multiple instances of NWDAF 100 may be deployed in a public land mobile network (PLMN). If multiple NWDAF instances are deployed, the architecture supports deploying the NWDAF as a central network function (NF), as a collection of distributed NFs, or as a combination of both. NWDAF 100 may interact with different entities for different purposes.

A NWDAF service consumer 120 may be a network function (NF) 121 (e.g., Policy Control Function (PCF), Network Slice Selection Function (NSSF), Mobility Function (AMF)), an Application Function (AF) 122, a process or function used in provisioning and managing a network or element within a network (e.g., Operations, Administration and Maintenance (OAM) 123). A NWDAF service consumer 120 may configure NWDAF 100 to track inference decisions and correlate the inference decisions with the network context in which they were made.

NWDAF 100 may interact with an Analytics Data Repository Function (ADRF) 110 for storage and retrieval of information. ADRF 110 may store and retrieve the collected data and analytics. ADRF 110 may allow storage and retrieval of data by other NFs 121.

NWDAF 100 may contain a model training logical function (MTLF) 103 for training one or more AI models. The one or more AI models may comprise one or more ML models.

NWDAF 100 may contain an Analytics logical function (AnLF) 101. AnLF 101 is a logical function which provides analytics service to one or more NWDAF service consumer 120. AnLF 101 may perform inference and derive inference outputs such as analytics, statistics, decisions and/or predictions. AnLF 101 may use the AI models trained by MTLF 103.

NWDAF 100 may contain a NWDAF Decision Logging Logical Function (DLLF) 102. DLLF 102 may be configured by mobile network operator and/or management plane.

DLLF 102 may collect, store, and retrieve an inference history of one or more AI models, and in particular of one or more of the AI models used by AnLF 101 to provide analytics service. The inference history of an AI model may comprise data related to one or more inferences performed by the AI model, and in particular one or more inference outputs generated by the AI model. An inference output may be a decision, a prediction, a recommendation, statistics and/or analytics.

DLLF 102 may store AI model inference history in ADRF 110. DLLF 102 may collect AI model inference history periodically, for a specified time period, or for the whole lifecycle of the AI model or of the application or function using the AI model.

DLLF 102 may collect, store, and retrieve data related to an inference performed by the AI model in relation to a network context in which the inference was performed by the AI model. The network context of an inference is the operational context of the communication network in which the inference is performed.

DLLF 102 may collect, label, store and retrieve network context information. The network context information comprises data indicative of the network context of the communication network. The network context information may comprise actual network condition as for example a slice load level, a NF load, Network performance or UE related analytics. The network context information may comprise analytics run by NWDAF AnLF 101 that capture the actual network condition. The network context information may comprise network state information, such as faults, management data from OAM, such as key performance indicators (KPIs), Minimization of Drive Tests (MDT), TraceJob information, base stations and/or cells powered-off, logs and/or historical analytics. The context information may also contain statistical information about data distribution of the Area of Interest (AOI) by running Area monitoring analytics.

DLLF 102 may associate an observed network context with one or more network context labels. This association may be used to relate the inference history with the network context information. To perform this association, DLLF 102 may perform a similarity check such that observed network contexts that are similar receive the same network context label.

DLLF 102 or ADRF 110 may keep and report a mapping between observed network contexts and corresponding network context labels. This mapping may be stored as one or more context-label table 111. A context label may be identified by a context ID. The context-label table 111 may associate network context information with one or more context ID identifying one or more context label.

DLLF 102 may generate, store, and retrieve inference-context history. Inference-context history may be a matching between AI model inference history and context information. DLLF 102 may track the different inference outputs generated by a given AI/ML in different network contexts. DLLF 102 may generate and store a matching between inference outputs and network contexts. This matching makes it possible to relate the decisions made by the AI model with the specific network context. This information can be used, for example, to select the best analytics producer or to manage AI model based on their performance over the actual mobile network context and/or use case.

NWDAF 100 may generate analytics in a way that exploits the inference-context history. NWDAF 100 may use the inference-context history to select an AI model based on the actual network context. The inference-context history may be used to identify a change in the actual network context and to select the AI model that performs best in the actual network context.

AnLF 101 may send, to DLLF 102, network context information representative of an actual network context, and request, in response, a context ID matching the network context information. AnLF 101 may then use the context ID to select one or more AI models for performing analysis services in the actual network context.

AnLF 101 may send, to DLLF 102, network context information representative of an actual network context, and request, in response, a combination of context ID and inference history matching the network context information. AnLF 101 may then use the combination of context ID and inference history to select one or more AI models for the specific network context.

AnLF 101 may send, to DLLF 102, network context information representative of an actual network context, and request, in response, a selection of one or more AI models for the specific network context.

MTLF 103 may use the inference-context history to detect outdated AI model. For example, MTLF 103 may detect that an AI model is outdated by comparing a prediction made by the AI model with an actual measurement. If the MTLF 103 determines that the AI model is outdated, MTLF 103 may trigger a retraining of the AI model (e.g., a global retraining or a retraining for a specific network context).

NWDAF 100 may use the inference-context history for monitoring of the AI model performance. NWDAF 100 may use the inference-context history to evaluate how well an AI model performs in different network context. In particular, NWDAF 100 may use the inference-context history to measure the AI model capability to generalize. NWDAF 100 may use the inference-context history to understand AI model behavior. In particular, NWDAF 100 may use the inference-context history for explaining the inference outputs (e.g., analytics, statistics, prediction, recommendation and/or decision) produced by the AI model.

A data format for the inference-context history may comprise one or more of the following parameters:

| Parameter | Description |
|---|---|
| Model ID | ML App/ML model ID. |
| Analytics ID | Analytics ID for which the AI model have |
| | been utilized. |
| Inference outputs | Outputs of the AI model produced over the |
| | actual network context. |
| Context ID | ID of the network context information. |
| | Similar network context has the same |
| | Context ID. |
| >Network Data analytics | Analytics produced by NWDAF to capture |
| | network status. For example, UE related |
| | analytics, slice load analytics . . . |
| >Management data | KPIs, TraceJob, PMs, MDT that can be |
| | collected by NWDAF to capture actual |
| | network status. |
| >Network state | Information about potential network faults, |
| | cells/base stations powered-off, etc.. |
| >Sub-area type | Sub-area type characterizes geographical |
| | areas with specific data properties. |

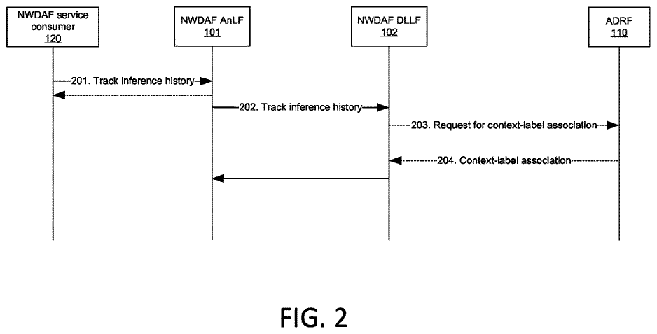

FIG. 2 is a signaling chart illustrating an example method for configuring tracking of inference-context history. In particular, embodiments can be used for configuring tracking of inference-context history at DLLF 102. FIG. 2 presents one example of operations at NWDAF 100. Some of the described operations may not be present in all example embodiments and the example embodiments may also comprise additional features/operations described elsewhere in this specification.

At operation 201, a NWDAF service consumer 120, for example NF 121, AF 121, or OAM 123, sends a request to AnLF 101 for tracking inference-context history for an analytics service. This request may be sent when the service consumer 120 subscribes or requests an analytics service provided by NWDAF 100. This may be performed, for example, by setting an attribute, for example inference_history_track attribute, to True, in a subscription request (e.g., Nnwdaf_AnalyticsSubscription_Subscribe). AnLF 101 may send an acknowledgement to NWDAF service consumer 120.

At operation 202, AnLF 101 instructs DLLF 102 to track inference-context history for the requested analytics service. This may be performed, for example, by setting an attribute, for example inference_history_track attribute, to True, in a subscription request.

At operation 203, DLLF 102 accesses the context-label table 111. The context-label table 111 stores the association between network context information and context ID. If the context-label table 111 is stored at ADRF 110, DLLF 102 retrieves the context-label table 111 from the ADRF 110. This can be done by sending a data management storage request (e.g., Nnadrf_DataManagement_Storage_Request) to the ADRF 110.

At operation 204, ADRF 110 forwards the context-label table 111 to the DLLF 102. DLLF 102 may send the context-label table 111 in a data management storage response (e.g., Nnadrf_DataManagement_Storage_Response). DLLF 102 may use the context-label table to collect, label, store and/or retrieve network context information.

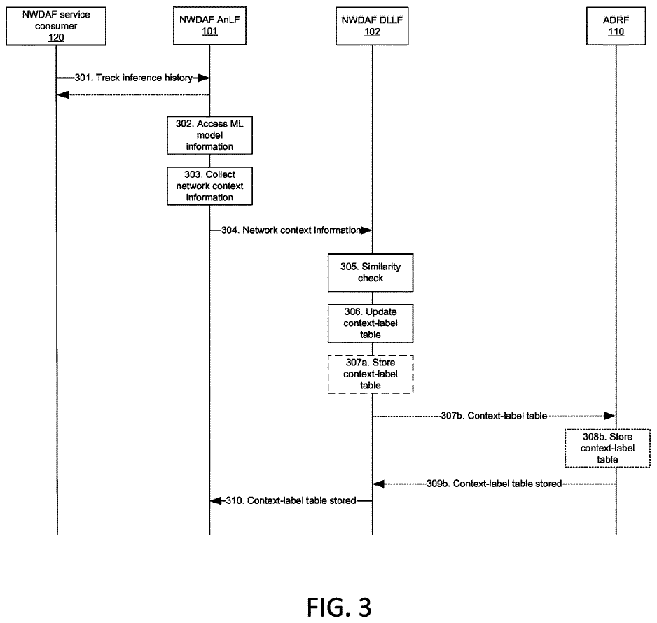

FIG. 3 is a signaling chart illustrating an example method for building and storing network context information. In particular, the method of FIG. 3 may be used to generate the context-label table 111. FIG. 3 presents one example of operations at NWDAF 100. Some of the described operations may not be present in all example embodiments and the example embodiments may also comprise additional features/operations described elsewhere in this specification.

At operation 301, a NWDAF service consumer 120, for example NF 121, AF 121, or OAM 123, sends a request to MWDAF AnLF 101 for tracking inference-context history for an analytics service. This request may be sent when the service consumer 120 subscribes or requests an analytics service provided by NWDAF 100. This may be performed, for example, by setting an attribute, for example inference_history_track attribute, to True, in a subscription request (e.g., Nnwdaf_AnalyticsSubscription_Subscribe). The requested analytics may be identified by an Analytics ID. AnLF 101 may send an acknowledgement to NWDAF service consumer 120.

At operation 302, AnLF 101 accesses and/or retrieves information about one or more AI models available for providing the requested analytics. The requested analytics may be identified by an Analytics ID. The information about the AI models may be accesses from MTLF 103.

At operation 303, AnLF 101 collects network context information. The network context information may be use case specific. For example, the network context information may include different information depending on the requested analytics. The network context information may be generated by running network data analytics as for example slice load level, NF load, Network performance or UE related analytics. The network context information may also be generated by collecting network state information as faults, relevant management data from OAM as KPIs, MDT, TraceJobs or base stations and/or cells powered-off, logs and/or historical analytics. The context information may also contain statistical information about data distribution of the AOI by running Area monitoring analytics.

At operation 304, AnLF 101 forwards the network context information to DLLF 102. This can be done, for example, using Ndllf_context information service.

At operation 305, DLLF 102 performs a similarity check between the context information received from AnLF 101 and context information collected in the past. If there is a context-label table, DLLF 102 may perform a similarity check between the context information received from AnLF 101 and context information stored in the context-label table. The similarity check can be done using any appropriate similarity measure and/or algorithm. For example, the similarity check can be done using a nearest neighbor approach to identify the similarity of two or more objects to each other based on algorithmic distance functions.

At operation 306, DLLF 102 generates or updates the context-label table with the context information received at operation 304. This can be done by assigning a context ID to the context information received at operation 304 based on the result of the similarity check. In particular, this can be done by mapping similar network context information to the same network context ID. This can be done, for example, using a clustering algorithm.

In case the context-label table is stored at DLLF 102, at operation 307a, DLLF 102 stores the generated or updated context-label table.

In case the context-label table is stored at ADRF 110, at operation 307b, DLLF 102 forwards the context-label table to ADRF 110 and instructs ADRF 110 to store the context-label table. At operation 308b, ADRF 110 stores the context-label table. At operation 309b, ADRF 110 notifies DLLF 102 that the context-label table has been successfully stored.

At operation 310, DLLF 102 informs AnLF 101 that the generated/updated context-label table has been successfully updated and stored.

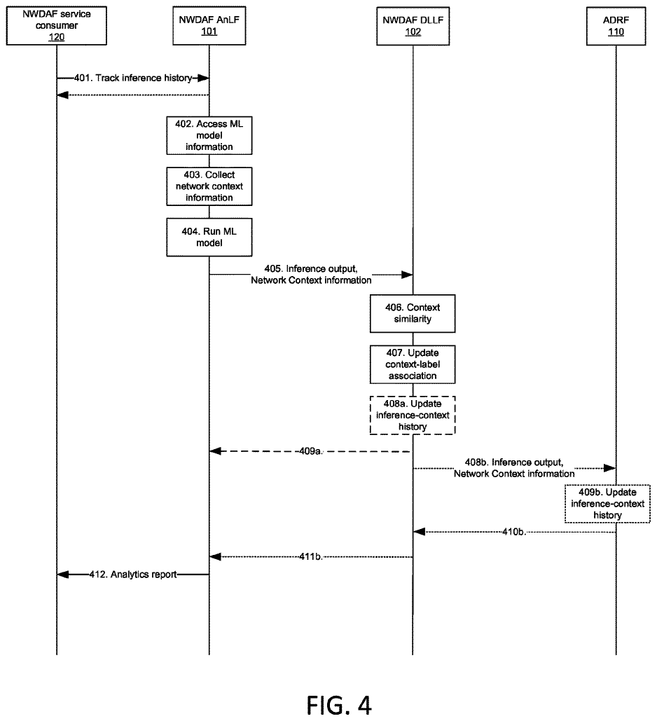

FIG. 4 is a signaling chart illustrating an example method for inference-context history tracking and storing. FIG. 4 presents one example of operations at NWDAF 100. Some of the described operations may not be present in all example embodiments and the example embodiments may also comprise additional features/operations described elsewhere in this specification.

At operation 401, a NWDAF service consumer 120, for example NF 121, AF 121, or OAM 123, sends a request to MWDAF AnLF 101 for tracking inference-context history for an analytics service. This request may be sent when the service consumer 120 subscribes or requests an analytics service provided by NWDAF 100. This may be performed, for example, by setting an attribute, for example inference_history_track attribute, to True, in a subscription request (e.g., Nnwdaf_AnalyticsSubscription_Subscribe). The requested analytics may be identified by an Analytics ID. AnLF 101 may send an acknowledgement to NWDAF service consumer 120.

At operation 402, AnLF 101 accesses and/or retrieves information about one or more AI models available for providing the requested analytics. The requested analytics may be identified by an Analytics ID. The information about the AI models may be accesses from MTLF 103.

At operation 403, AnLF 101 collects network context information. This can be done similarly to operation 303.

At operation 404, AnLF 101 runs one or more AI model for producing the requested analytics. The AI model performs one or more inferences and generates one or more inference outputs.

At operation 405, AnLF 101 sends, to DLLF 102, the output of the inference and the network context information representative of the network context in which the inference was performed. The output of the inference may comprise one or more of a decision, a prediction, a recommendation, analytics, and/or statistics generated by the AI model. AnLF 101 may send, in addition to the output of the inference and the network context information, the model ID of the AI model used to perform the inference, the Analytics ID of the analytics service for which the AI model has been employed. The tracking of the inference may be performed periodically, or for a specific time window or for the whole AI model lifecycle. The forwarding of the result of the inference may be done by using Ndllf_DataManagement_Store service. AnLF 101 may additionally instruct DLLF 102 to store the result of the inference.

At operation 406, DLLF 102 performs a similarity check between the context information received from AnLF 101 and context information collected in the past. If there is a context-label table, DLLF 102 may perform a similarity check between the context information received from AnLF 101 and context information stored in the context-label table. The similarity check can be done similarly to operation 305.

At operation 407, DLLF 102 generates or updates the context-label table with the context information received at operation 405. This can be done by assigning a context ID to the context information received based on the result of the similarity check. In particular, this can be done by mapping similar network context information to a same network context ID. This can be done, for example, using an appropriate clustering algorithm. This can be done similarly to operation 306.

If the inference-context history is stored at DLLF 102, at operation 408a, DLLF 102 generates or updates the inference-context history with the inference output received at operation 405 and the context ID determined for the network context at operation 407. The inference-context history associates the inference output with the network context in which the inference was performed. At operation 409a, DLLF 102 may inform the AnLF 101 that the inference-context history has been successfully generated/updated.

If the inference-context history is stored at ADRF 110, at operation 408b, DLLF 102 sends the inference output and the network context ID to ADRF 110. This can be included in a storage request. DLLF 102 may also send the Model ID, the analytics ID. At operation 409b, ADRF 110 generates or updates the inference-context history with the inference output received at operation 405 and the context ID determined for the network context at operation 407. This can be done similarly to operation 408a. At operation 410b, ADRF 110 informs DLLF 102 that the inference-context history has been successfully generated/updated. At operation 411b, DLLF 102 informs AnLF 101 that the inference-context history has been generated/updated.

At operation 412, AnLF 102 provides the requested analytics report to the NWDAF service consumer 120. This can be done with Nnwdaf_AnalyticsSubscription_Notify.

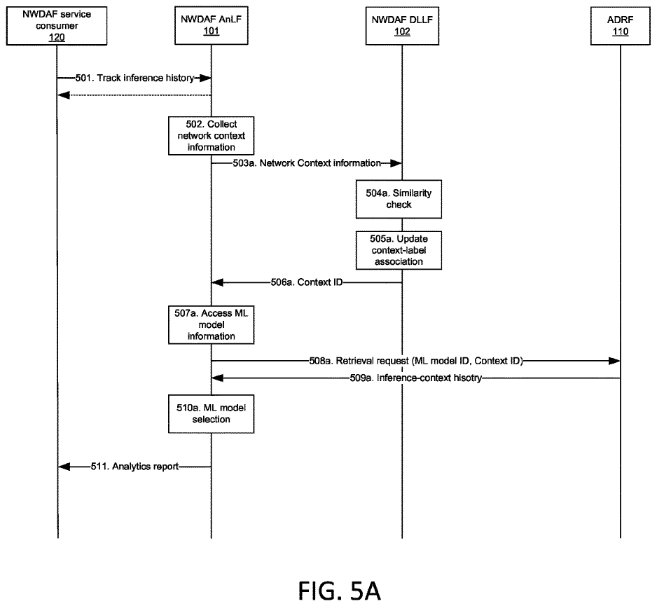

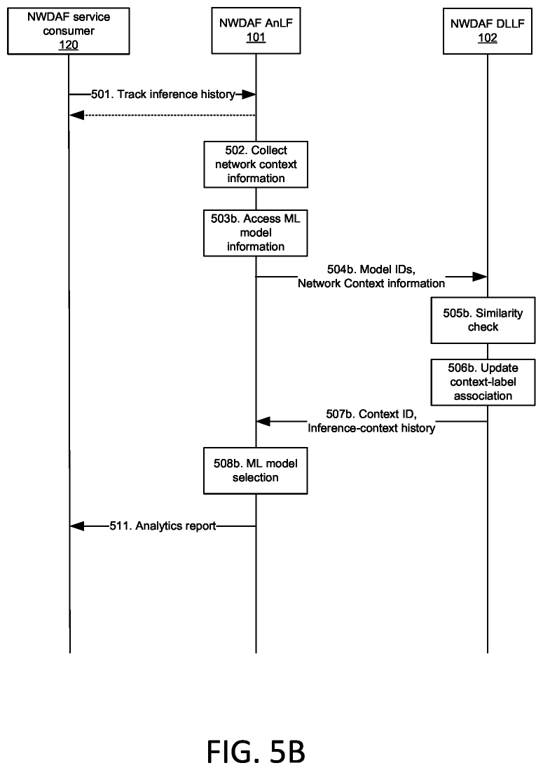

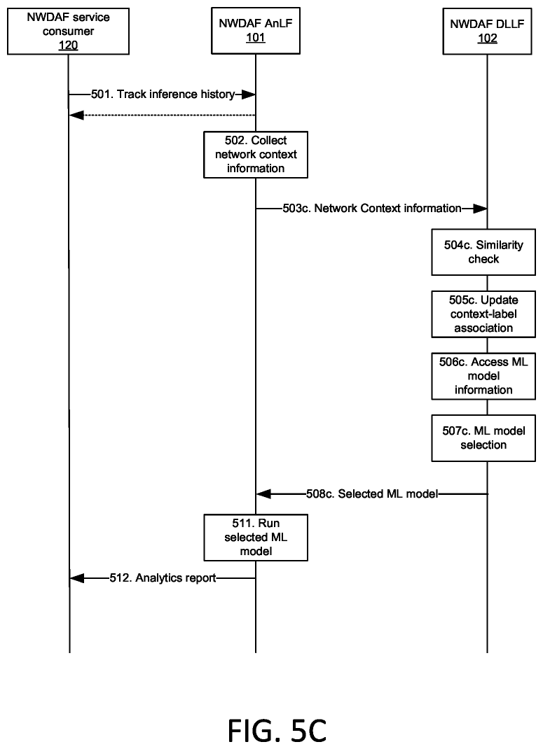

FIG. 5A is a signaling chart illustrating an example method for AI/M model selection using inference-context history. FIG. 5A presents one example of operations at NWDAF 100. Some of the described operations may not be present in all example embodiments and the example embodiments may also comprise additional features/operations described elsewhere in this specification.

At operation 501, a NWDAF service consumer 120, for example NF 121, AF 121, or OAM 123, sends a request to MWDAF AnLF 101 for tracking inference-context history for an analytics service. This request may be sent when the service consumer 120 subscribes or requests an analytics service provided by NWDAF 100. This may be performed, for example, by setting an attribute, for example inference_history_track attribute, to True, in a subscription request (e.g., Nnwdaf_AnalyticsSubscription_Subscribe). The requested analytics may be identified by an Analytics ID. AnLF 101 may send an acknowledgement to NWDAF service consumer 120.

At operation 502, AnLF 101 collects network context information. This can be done similarly to operation 303. The network context corresponding to the network context information collected at operation 502 is called the actual network context.

At operation 503a, AnLF 101 sends a request to DLLF 102 requesting the DLLF 102 to provide a context ID for the network context information collected at operation 502. The request comprises the network context information collected at operation 502. The request can be sent using Ndllf_ContextMatching_Request service.

At operation 504a, DLLF 102 performs a similarity check between the network context information collected at operation 502 and network context information collected in the past. If there is a context-label table, DLLF 102 may perform a similarity check between the network context information collected at operation 502 and the context information stored in the context-label table. The similarity check can be done similarly to operation 305.

At operation 505a, DLLF 102 updates the context-label table with the context information received at operation 405. This can be done by assigning a context ID to the network context information collected at operation 502 based on the result of the similarity check. This can be done similarly to operation 306.

At operation 506a, DLLF 102 sends, to the AnLF 101, the context ID assigned to the context information received at operation 405. This can be done using Ndllf_ContextMatching_Request_response service.

At operation 507a, AnLF 101 accesses and/or retrieves information about one or more candidate AI models. The one or more candidate AI models may be identified based on the context ID assigned to the context information received at operation 405. In particular, AnLF 101 may accesses and/or retrieves information about one or more candidate AI models previously used in a network context associated with the context ID assigned to the context information received at operation 405. The information about the one or more AI models may be accesses from MTLF 103.

At operation 508a, AnLF 101 sends a request to ADRF 110 for the inference-context history associated with the one or more candidate AI models identified at operation 507a. The request may specify a Model ID for the one or more candidate AI models identified at operation 507a. AnLF 101 may only request inference-context history associated with the context ID received at operation 506a. The request may specify, along with the Model IDs of the candidate AI models, the context ID received at operation 506a. Furthermore, AnLF 101 may request inference-context history only for a specified time interval, one or more specified AOI, and/or other specified parameters. If not specified, all the available inference-context history for the AI models specified may be returned.

At operation 509a, ADRF 110 returns the inference-context history requested at operation 508a. This can be done using Ndllf_InferenceHistory_Request_response service.

At operation 510a, AnLF 101 selects at least one AI model from among the one or more candidate AI models based on the inference-context history received at operation 509a. In particular, AnLF 101 may select the AI model by identifying, in the inference-context history, the AI model that performed the best in network contexts associated with the same context ID. A performance of an AI model can be assessed using a performance metric such as a model inference accuracy. If AnLF 101 detects a change in the current network context, AnLF 101 can decide to select the AI model based on an updated current network context.

At operation 511, AnLF 101 runs the at least one selected AI model for producing the requested analytics.

At operation 512, AnLF 102 provides the requested analytics report to the NWDAF service consumer 120. This can be done with Nnwdaf_AnalyticsSubscription_Notify. AnLF may monitor the network context and request a new AI model in case it detects a change. The same monitoring process could be also performed by DLLF.

FIG. 5B is a signaling chart illustrating an example method for AI/M model selection using inference-context history. FIG. 5B presents one example of operations at NWDAF 100. Some of the described operations may not be present in all example embodiments and the example embodiments may also comprise additional features/operations described elsewhere in this specification.

At operation 501, a NWDAF service consumer 120, for example NF 121, AF 121, or OAM 123, sends a request to MWDAF AnLF 101 for tracking inference-context history for an analytics service.

At operation 502, AnLF 101 collects network context information. This can be done similarly to operation 303. The network context corresponding to the network context information collected at operation 502 is called the actual network context.

At operation 503b, AnLF 101 accesses and/or retrieves information about one or more candidate AI models. The information about the one or more AI models may be accesses from MTLF 103.

At operation 504b, AnLF 101 sends a request to ADRF 110 for the inference-context history associated with the one or more candidate AI models identified at operation 503b. The request may specify a Model ID for each one of the candidate AI models identified at operation 503b. AnLF 101 may only request inference-context history associated with the actual context network. The request may specify the context information collected at operation 502. Furthermore, AnLF 101 may request inference-context history only for a specified time interval, one or more specified AOI, and/or other specified parameters. If not specified, all the available inference-context history for the AI models specified may be returned.

At operation 505b, DLLF 102 performs a similarity check between network context information collected at operation 502 and network context information collected in the past. If there is a context-label table, DLLF 102 may perform a similarity check between the network context information collected at operation 502 and the context information stored in the context-label table. The similarity check can be done similarly to operation 305.

At operation 506b, DLLF 102 updates the context-label table with the context information collected at operation 502. This can be done by assigning a context ID to the network context information collected at operation 502 based on the result of the similarity check. This can be done similarly to operation 306.

At operation 507b, ADRF 110 returns the inference-context history requested at operation 504b. This can be done using Ndllf_InferenceHistory_Request_response service.

At operation 508b, AnLF 101 selects at least one AI model from among the one or more candidate AI models based on the inference-context history received at operation 507b. In particular, AnLF 101 may select the AI model by identifying, in the inference-context history, the AI model that performed the best in network contexts associated with the same context ID. If AnLF 101 detects a change in the current network context, AnLF 101 can decide to select the AI model based on an updated current network context.

At operation 511, AnLF 101 runs the at least one selected AI model for producing the requested analytics.

At operation 512, AnLF 102 provides the requested analytics report to the NWDAF service consumer 120. This can be done with Nnwdaf_AnalyticsSubscription_Notify. AnLF may monitor the network context and request a new AI model in case it detects a change. The same monitoring process could be also performed by DLLF.

FIG. 5C is a signaling chart illustrating an example method for AI/M model selection using inference-context history. FIG. 5C presents one example of operations at NWDAF 100. Some of the described operations may not be present in all example embodiments and the example embodiments may also comprise additional features/operations described elsewhere in this specification.

At operation 501, a NWDAF service consumer 120, for example NF 121, AF 121, or OAM 123, sends a request to MWDAF AnLF 101 for tracking inference-context history for an analytics service. This request may be sent when the service consumer 120 subscribes or requests an analytics service provided by NWDAF 100. This may be performed, for example, by setting an attribute, for example inference_history_track attribute, to True, in a subscription request (e.g., Nnwdaf_AnalyticsSubscription_Subscribe). The requested analytics may be identified by an Analytics ID. AnLF 101 may send an acknowledgement to NWDAF service consumer 120.

At operation 502, AnLF 101 collects network context information. This can be done similarly to operation 303. The network context corresponding to the network context information collected at operation 502 is called the actual network context.

At operation 503c, AnLF 101 sends a request to DLLF 102 requesting the DLLF 102 to provide a AI model for providing the requested analytics in the actual network context. The request comprises the network context information collected at operation 502. The request may further comprise the Analytics ID. The request can be sent using Ndllf_MLmodelRetrieval_Request service.

At operation 504c, DLLF 102 performs a similarity check between network context information collected at operation 502 and network context information collected in the past. If there is a context-label table, DLLF 102 may perform a similarity check between the network context information collected at operation 502 and the context information stored in the context-label table. The similarity check can be done similarly to operation 305.

At operation 505c, DLLF 102 updates the context-label table with the context information collected at operation 502. This can be done by assigning a context ID to the network context information collected at operation 502 based on the result of the similarity check. This can be done similarly to operation 306.

At operation 506c, DLLF 102 accesses and/or retrieves information about one or more candidate AI models. The one or more candidate AI models may be identified based on the context ID assigned to the context information received at operation 405. In particular, AnLF 101 may accesses and/or retrieves information about one or more candidate AI models previously used in a network context associated with the context ID assigned to the context information received at operation 405. The information about the one or more AI models may be accesses from MTLF 103.

At operation 507c, DLLF 102 selects at least one AI model from among the one or more candidate AI models. In particular, AnLF 101 may select the AI model by identifying, in the inference-context history, the AI model that performed the best in network contexts associated with the same context ID. If AnLF 101 detects a change in the current network context, AnLF 101 can decide to select the AI model based on an updated current network context.

At operation 508c, DLLF 102 provides to AnLF 101 the at least one AI model selected at operation 507c. This can be done using Ndllf_MLmodelRetrieval_Request_response service.

At operation 511, AnLF 101 runs the selected AI model for producing the requested analytics.

At operation 512, AnLF 102 provides the requested analytics report to the NWDAF service consumer 120. This can be done with Nnwdaf_AnalyticsSubscription_Notify. AnLF may monitor the network context and request a new AI model in case it detects a change. The same monitoring process could be also performed by DLLF.

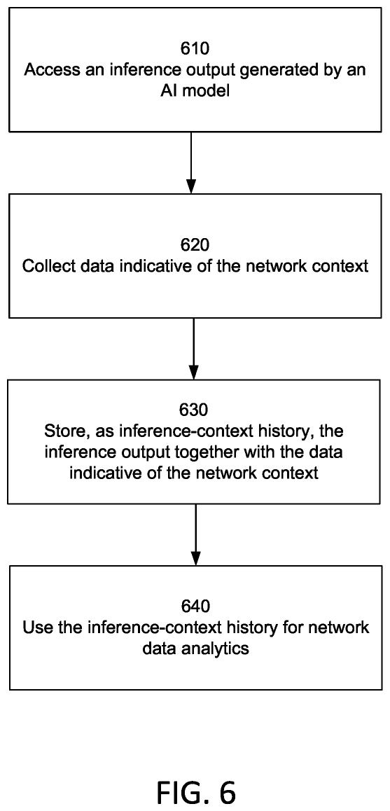

FIG. 6 illustrates an example embodiment of the subject matter described herein illustrating a flow chart representation of a method.

At operation 610, the method may comprise accessing an inference output generated by an AI model, the inference output being generated within a network context of a communication network.

At operation 620, the method may comprise collecting data indicative of the network context.

At operation 630, the method may comprise storing, as inference-context history, the inference output together with the data indicative of the network context.

At operation 640, the method may comprise using the inference-context history for network data analytics of the communication network. Using the inference-context history for network data analytics of the communication network may include selecting one or more of the AI models for performing the network data analytics, monitoring a performance of one or more of the AI models to be used for network data analytics, and/or triggering a retraining of one or more of the AI models to be used for network data analytics.

Further features of the methods directly result from the functionalities and parameters of the NWDAF 100, as described in the appended claims and throughout the specification and are therefore not repeated here. Different variations of the methods may be also applied, as described in connection with the various example embodiments.

An apparatus may comprise means for performing any aspect of the method(s) described herein. According to an example embodiment, the means comprises at least one processor, and memory comprising program code, the at least one processor, and program code configured to, when executed by the at least one processor, cause performance of any aspect of the method.

The functionality described herein can be performed, at least in part, by one or more computer program product components such as software components. According to an example embodiment, the apparatus comprises a processor configured by the program code when executed to execute the example embodiments of the operations and functionality described. Alternatively, or in addition, the functionality described herein can be performed, at least in part, by one or more hardware logic com-ponents. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and Graphics Processing Units (GPUs).

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps or operations of the methods described herein may be carried out in any suitable order, or simultaneously where appropriate. Additionally, individual blocks may be deleted from any of the methods without departing from the scope of the subject matter described herein. Aspects of any of the embodiments described above may be combined with aspects of any of the other embodiments described to form further embodiments without losing the effect sought.

The term ‘comprising’ is used herein to mean including the method, blocks, or elements identified, but that such blocks or elements do not comprise an exclusive list and a method or apparatus may contain additional blocks or elements.

As used in this application, the term ‘circuitry’ may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims.

As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from scope of this specification.

1. An apparatus comprising:
at least one processor; and
at least one memory storing instructions that, when executed by the at least one processor, cause the apparatus at least to perform operations comprising:
for one or more artificial intelligence-AI-models:
accessing an inference output generated by the AI model, the inference output being generated in a network context of a communication network;
collecting data indicative of the network context; and
storing, as inference-context history, the inference output together with the data indicative of the network context; and
using the inference-context history for network data analytics of the communication network.

2. The apparatus according to claim 1, wherein using the inference-context history for network data analytics comprises:
selecting, among the one or more AI models, an AI model for performing the network data analytics, the AI model being selected based on the inference-context history; and
running the selected AI model to produce the network data analytics.

3. The apparatus according to claim 1, wherein storing the inference output together with the data indicative of the network context comprises:
associating the network context with a label; and
storing the inference output together with the label.

4. The apparatus according to claim 2, wherein storing the inference output together with the data indicative of the network context comprises associating data indicative of the network context with a label; and wherein selecting the AI model for performing the network data analytics comprises selecting the AI model based on the inference-context history associated with the label.

5. The apparatus according to claim 3, wherein associating the network context with the label comprises:
performing a similarity check between the data representative of the network context and data representative of a historical network context stored in a context-label table;
assigning a label to the network context based on the result of the similarity check; and
updating the context-label table by storing the data indicative of the network context together with the label in the context-label table.

6. The apparatus according to claim 1, wherein using the inference-context history for network data analytics comprises:
monitoring a performance of one or more of the AI models to be used for network data analytics, the performance of the AI model being monitored by analyzing the inference-context history associated with the AI model.

7. The apparatus according to claim 1, wherein the inference output is a prediction for a parameter, and wherein using the inference-context history for network data analytics comprises:
comparing the prediction for the parameter with a measured value of the parameter; and
triggering a retraining of the AI model based on determining that the prediction for the parameter does not match the measured value of the parameter.

8. The apparatus according to claim 1, wherein the data indicative of the network context comprises one or more of:
a slice load level, a network function load, a network performance or user equipment related analytics,
a general network state, or
information about Area of Interest sub-areas type.

9-11. (canceled)
